(19) United States
(12) Patent Application Publication
(10) Pub. No.: US 2005/0254901 A1
(43) Pub. Date: Nov. 17, 2005

(54) Offshore oil transportation system

(76) Inventor: Peter M. Lovie, Houston, TX (US)

Correspondence Address: Alan R. Thiele;Strasburger & Price, LLP, 901 Main St., Suite 4400, Dallas, TX, 75202, US

(21) Appl. No.: 10/706,414

(22) Filed: Nov. 12, 2003

Related U.S. Application Data
(60) Provisional application No. 60/425,398, filed on Nov. 12, 2002.

(51) Int. Cl. F16L 1/00; E02D 27/38

(52) U.S. Cl. 405/169; 405/158; 405/210

(57) ABSTRACT

The disclosed offshore oil transportation system includes an unmoored, dynamically positionable FSO located at a predetermined distance with respect to an offshore production platform or with respect to a point on the earth's surface. The FSO receives crude oil from offshore platforms and then offloads the crude oil into shuttle tankers which move the crude oil to onshore refineries or storage facilities.

### REFERENCE TO RELATED APPLICATION

This application claims priority from U.S. Provisional Patent Application Ser. No. 60/425,398 filed Nov. 12, 2002.

### BACKGROUND OF THE INVENTION

1. Field

The present invention pertains to an offshore crude oil transportation system; more particularly, the present invention pertains to a transportation system and method for moving oil produced at offshore production locations to onshore refineries or storage tanks.

2. Background

Since crude oil was first discovered in reservoirs located beneath the sea floor and offshore systems have been developed to both remove the crude oil from these offshore reservoirs and process the crude oil from offshore production locations, a variety of different methods have been used to transport the crude oil produced offshore to refineries or storage tanks onshore. Once onshore, the crude oil can be held temporarily for later use or sale or processed at a refinery to make a variety of usable products.

One of the earliest methods of transporting crude oil produced offshore to onshore refineries or storage tanks was to move the crude oil through pipelines laid on the ocean floor. In recent years, as the number of offshore wells has increased, new technologies have enabled drilling deeper wells in deeper and deeper water farther and farther from shore. Because each new production location does not include its own proprietary pipeline to transport crude oil to shore, some owners and operators of offshore wells connect up to a network of consolidated pipelines. Practically, the crude oil produced from a number of offshore wells, known as “live crude oil” in the industry, is processed at a production facility offshore to separate gas, water and solid contaminants. Once the contaminants have been removed, live crude oil is typically called “stabilized crude oil.” The stabilized crude oil is the fluid that is transported onshore through a subsea pipeline network.

In a network of consolidated pipelines such as found in the Gulf of Mexico, upstream pipelines from the offshore production locations (typically called an “offshore platform”) flow into one or more common pipelines. The use of a common pipeline commingles the stabilized crude oil produced from different offshore production locations. From the common pipeline, the flow of commingled stabilized crude oil is then diverted into a network of smaller pipelines branching out from the common pipeline. These smaller pipelines enable making a connection from the common pipeline to dedicated connections serving onshore refineries or leading directly to land-based storage tanks.

While simple in concept, the use of a pipeline network beginning at the offshore platforms, coming together or commingling the stabilized crude oil into a common pipeline, and then branching out toward dedicated connections before delivering the stabilized crude oil to its onshore destination, is not without its complications. These complications are best understood from the viewpoint of the operator of an offshore oil producing platform whose return on investment comes from producing live crude oil from subsea wells, and then selling the produced stabilized crude oil at the highest possible price to an onshore refinery or owner of a land-based storage facility.

There are three market factors that the operator of an offshore oil producing platform must consider when making a contract to deliver stabilized crude oil produced by subsea wells.
(1) the transportation fees to move the stabilized crude oil from an offshore production location to a location onshore. When a pipeline network is used, the transportation fees include the usage fees that must be paid by the operator of the offshore platform to the pipeline owner(s) for use of common pipelines to move the stabilized crude oil produced from the offshore production location to a refinery or storage tank onshore;
(2) the capability of an onshore refinery to refine the stabilized crude oil produced by an offshore well. Because the stabilized crude oil produced from an offshore production location has its own unique chemical signature, the operator of an offshore platform can best sell the crude oil produced from an offshore production location to an onshore refinery whose processing equipment has been designed and constructed to best process stabilized crude oil which best matches the chemical signature of the stabilized crude oil produced at a particular offshore production location. Where there is a mismatch between the stabilized crude oil produced offshore and the capabilities of the onshore refinery, the cost to refine the stabilized crude oil into usable products increases. The higher the cost of refining stabilized crude oil, the smaller the incentive of the operator of an onshore refinery to buy stabilized crude oil produced from certain offshore production locations; and
(3) the market price for stabilized crude oil that the onshore refinery is willing to pay. Just as the operator of an offshore oil producing platform seeks to maximize return on investment, so too will the operator of an onshore refinery seek to obtain the highest return on investment by knowing both the cost to process various different types of stabilized crude oil into usable products and the market price for certain refinery products produced from the stabilized crude oil. To maximize return on investment, the refinery operator will endeavor to obtain stabilized crude oil that can be processed at the lowest cost into usable products that can be sold at the highest price. In addition to the cost of processing the stabilized crude oil, operators of onshore refineries are in competition with one another to assure a continued supply of stabilized crude oil from offshore and onshore sources to be transferred into refinery products that can be readily sold for the greatest return.

The deeper the ocean waters in which offshore wells are located, the higher the cost of transportation to bring the stabilized crude oil onshore. Deeper water necessitates the construction of more sophisticated pipelines to withstand both the higher pressures at greater depths and the lower temperatures in deeper waters. The cooler water at greater depth reduces the temperature of the fluid in the pipeline. Cooler fluids may become thicker and thus more difficult to move. In extreme cases, cooled fluid can actually become thick enough to stop the flow within a pipeline. The more sophisticated the pipeline, the greater the cost to build and the higher the usage fee. Accordingly, there is a growing incentive on the part of offshore platform operators to find ways to avoid the ever increasing costs of using sophisticated pipeline networks and to minimize the cost of transporting oil from offshore wells to onshore storage facilities or refineries.

One attempt to minimize the cost of transporting oil through a pipeline network has been through the use of proprietary pipelines for selected portions of the travel path from offshore to the onshore storage facility or refinery.

When the use of pipelines to transport stabilized crude oil from offshore to onshore locations becomes physically impractical for one or more factors, to include the topography of the sea bottom, shuttle tankers have been used for oil transport in place of subsea pipelines. This was one of the first uses of shuttle tankers. Commonly, the production platform was either a ship with storage tanks for temporarily holding stabilized crude oil or a type of fixed platform founded on the seabed which incorporated storage tanks. As the storage tanks accumulated oil to where a full load for a shuttle tanker could be provided, a shuttle tanker would offload the oil and transport the oil to onshore locations

The transportation is performed either on a “dedicated” basis (shuttle tanker(s) contracted exclusively for specific fields and producers), or on a Contract of Affreightment (CoA) basis, where one or more shuttle tankers are called on as needed from a large fleet, and may work for a variety of different fields and producers.

With dedicated service, the transportation fare significantly varies with production rate, while under a CoA it is normally a flat rate, assuming here that in both cases there is capability for storage at the offshore platform.

Where there is no storage capability availability at the offshore platform, as is typical in the U.S. Gulf of Mexico, then another process can be used instead of the traditional shuttling model described above. This process has become known as Direct Shuttle Loading (DSL) in the industry. In DSL, the shuttle tankers load crude oil into one or more on-board tanks directly from the offshore production locations by connecting a flexible hose to a portal or connection at an offshore production platform. When the tanks of the shuttle tanker are loaded, the shuttle tankers transport the stabilized crude oil to a predetermined onshore location.

Shuttle tanker operators have learned that profits can be lost if the shuttle tankers remain idle for extended periods of time. Accordingly, efforts are made to maximize economic use of the shuttle tankers in DSL service by having at least one empty or partially empty shuttle tanker waiting in line behind a shuttle tanker being filled at an offshore oil-producing platform so that once the tanks on a shuttle tanker are filled, another empty or partially empty shuttle tanker is available. If properly staged, the wait time between the filling of empty shuttle tankers can be minimized. Generally, whether in DSL operation or in the more common traditional shuttling model, the economics of using a fleet of shuttle tankers to service offshore production locations is favorable if the utilization rate of the shuttle tankers is high and the wait time for receiving a load of crude oil produced by an offshore platform is minimized.

The use of a fleet of shuttle tankers to provide for transport of the crude oil also provides an additional advantage over the use of an undersea pipeline system. Because all undersea pipelines do not run from all offshore production locations to all onshore refineries, the producers of crude oil can only direct the crude oil to the refineries or storage facilities having dedicated connections serviced by downstream connections to a pipeline network, even though the producers of crude oil may have received an offer for a higher price from a refinery or storage facility which is not reachable. When shuttle tankers are used, the shuttle tankers can be easily directed to the refinery or storage facility that has lodged the highest bid price for the stabilized crude oil produced from an offshore location, and that destination can be changed at will.

Because a shuttle tanker must maintain its physical position in the water with respect to the location of a producing offshore platform to facilitate loading of the empty tanks in the tanker, most shuttle tankers include sophisticated dynamic positioning systems. These dynamic positioning systems are programmed to continually make small adjustments to the position of the shuttle tanker to accurately maintain the position of the shuttle tanker in the water. In certain situations, the position of a shuttle tanker may actually be a moving position to accommodate the motions of an offshore production platform when the offshore platform is a floating platform or is designed to move in response to the action of waves and winds. Thus, a sophisticated system is needed to assure proper relative motion between the shuttle tanker and the offshore platform. Specifically, shuttle tankers with sophisticated dynamic positioning systems use a variety of different propulsion systems at predetermined locations around the shuttle tanker's hull to enable the shuttle tanker to maintain essentially a constant position with respect to a point on the earth's surface or a predetermined spacing from an object such as a stationary or moving offshore oil producing platform, irrespective of the forces of currents or wind on the shuttle tanker.

In yet another system for the transportation of crude oil from offshore production locations to onshore refineries of storage facilities, a storage tanker or Floating Storage Offshore (FSO) vessel is moored adjacent to an offshore producing platform. Connections from the various offshore platforms producing stabilized crude oil from one or more undersea reservoirs causes the live crude oil to pass from the subsea reservoirs into the producing platform, be processed, and then sent to the storage tanker (FSO). The mooring of the FSO adjacent to an offshore production platform allows the FSO to weathervane or move about its mooring or attachment to the sea floor in response to the forces of wind and ocean current. Shuttle tankers then pull alongside the FSO—or more commonly bow to stern (tandem)—and offload stabilized crude oil for transport to onshore refineries.

Often misunderstood and overlooked is the difficult and expensive problem of mooring an FSO so that the FSO stays in a relatively stable location despite the forces from the ocean currents, waves, and the prevailing winds while, at the same time, not hampering the accessibility by the shuttle tankers which periodically offload the crude oil from the FSO. The deeper the water in which an FSO is placed, the more difficult, the more complex, and the more expensive it is to moor the large FSO so that its position remains relatively unchanged. Such mooring and offloading systems have been described in the following U.S. Pat. Nos. 5,584,607; 5,275,510; 4,838,823.

Because of the ability of shuttle tankers to dynamically maintain a fixed position in the water during the process of transferring crude oil from the FSO, the use of a bottom moored FSO has received wide acceptance in locations such as the North Sea. In many applications, the FSO itself is used as a production platform tied into an offshore well. When both storage and production of stabilized crude oil occur on one vessel, it is called a Floating Production Storage Offloading (FPSO) vessel.

In all of the foregoing crude oil transportation systems, there is an economic cost limit beyond which the crude oil transportation system cannot be used and still enable operators of offshore oil producing platforms, shuttle tanker operators, and operators of offshore refineries to all obtain a suitable return on their investment.

When fleets of shuttle tankers are used, the distance between the offload point onshore and the offshore load point, plus the time spent waiting for a cargo load to become available, determines the amount of time that the shuttle tankers must operate without carrying a load. The greater the time that a shuttle tanker operates without carrying a load of stabilized crude oil, the higher its operational cost.

Finally, because of the high cost of mooring an FSO, there is an economic limit to the depth of water at which an FSO can be economically used. In very deep water, the cost of simply mooring an FSO to the sea bottom is so expensive that the use of an FSO with a fleet of shuttle tankers may not economically justify the use of this transportation system for stabilized crude oil produced offshore.

Calculation of typical tariffs for oil transportation by shuttle tankers from offshore platforms with storage capability show a competitive pattern, but the same calculations for offshore platforms without storage capabilities using DSL are much less competitive. This is particularly true in the U.S. Gulf of Mexico where higher cost double-hulled Jones Act compliant shuttle tankers are mandated by law. Thus, a method whereby shuttle tanker service for platforms without storage capability will have particular competitive value for operators of offshore platforms located in U.S. waters such as the Gulf of Mexico. Thus, the arrangement here of an urnmoored, dynamically positioned FSO adjacent to an offshore platform without storage to provide crude oil transportation services, as a TLP, spar, or semi-submersible has been associated with the trademarks SEPARATE STORAGE SHUTTLING™ and S-S-S™.

Thus, a need still remains in the art for an offshore transportation system and method that can be used economically to move crude oil produced at deep water platforms, particularly those without storage capabilities, to onshore refineries or storage facilities.

### SUMMARY

The transportation method and system of the present invention provides an economical way to move stabilized crude oil the large distances from deep water offshore oil producing platforms, particularly those without storage capability to onshore storage facilities or refineries. One embodiment of the disclosed system and method is centered around the use of a dynamically positionable, unmoored FSO which is serviced or offloaded by a fleet of shuttle tankers. The shuttle tankers transport the crude oil to a predetermined onshore refinery or storage facility from a dynamically positionable, unmoored FSO. The second embodiment of the present invention is a system and method for transporting crude oil from an offshore platform without storage capabilities to onshore destinations using one or more shuttle tankers.

By using a dynamically positionable, unmoored FSO and not requiring the FSO to be moored over a fixed location by attaching the FSO to the sea bottom, (a) the large cost of constructing a system to moor the FSO to the sea bottom in deep water is eliminated; and (b) time can often be reduced between completion of a contract for transportation services and the start of the transportation service. Instead, the FSO can be positioned with respect to a predetermined point on the earth's surface or relative to a floating or moving platform or strategically located within or in close proximity to a group of offshore oil producing platforms by positioning systems carried on board the FSO. Because of the dynamically positioning capability of the FSO, a flexible pipeline can be connected from the offshore production location to the unmoored, dynamically positionable FSO. Shuttle tankers can then offload the stabilized crude oil to take the stabilized crude oil to that onshore refinery or to storage facilities whose capabilities and needs best match the chemical signature of the stabilized crude oil and whose purchase price offer provides the biggest return for the operator of the offshore oil-producing platform. Because of the dynamic positioning capabilities of a modern FSO, the ability exists to position the FSO closer to the producing platform than is possible if the FSO were moored to the ocean bottom. Consequently, the length of the high priced hose which connects the platform to the FSO can be much shorter, thus reducing the cost of the transportation system and method and providing operational advantages such as less pumping and lower risk of blockage in the hose.

Because most FSO's have multiple compartments in which crude oil may be temporarily stored, it is possible to segregate various types of crude oil with distinct chemical signatures by compartment and then offload a particular type of crude oil to a shuttle tanker programmed to travel to an onshore refinery best able to process that type of crude oil. Similarly, if the offshore platform produces crude oil for multiple owners (e.g., where two or more oil companies own production at an offshore platform), each owner can assure segregated storage of its crude oil, if desired. Additional value to the producers is thus provided when the shuttle tankers can deliver segregated cargoes of crude oil to their respective destinations.

In the second embodiment, the shuttle tankers reduce the cost to operators of offshore platforms without storage capabilities by offloading crude oil directly into the shuttle tankers. Offshore platforms without storage capabilities typically included tension leg platforms (TLP); a spar, or a semi-submersible platform.

### BRIEF DESCRIPTION OF THE DRAWING FIGURES

A better understanding of the offshore oil transportation system of the present invention may be had by reference to the drawing figures, wherein:

FIG. 1 is a schematic view of the route to be traveled by shuttle tankers; and

FIG. 2A and 2B are graphs showing the typical cost of tariffs for transportation by shuttle tankers against stabilized crude oil production rates.

### DESCRIPTION OF THE EMBODIMENTS

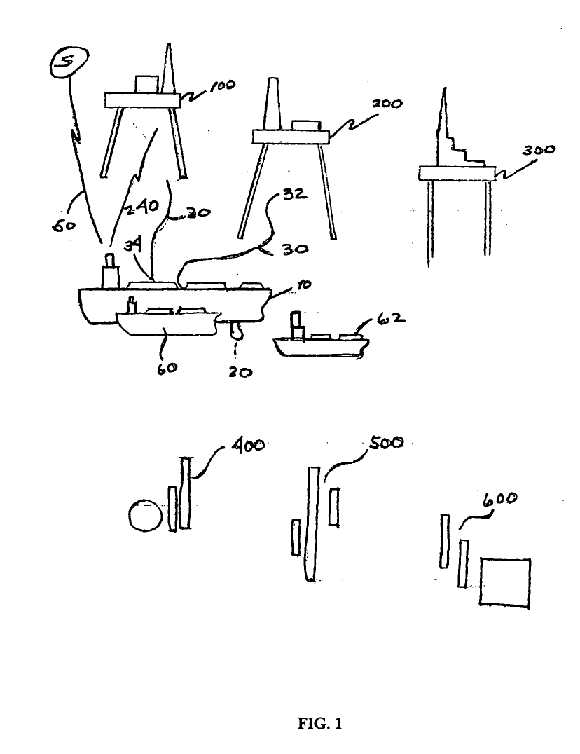

A still better understanding of the transportation system and method of the present invention may be had by reference to FIG. 1. Therein it may be seen that a variety of offshore platforms 100, 200, 300 are located in deep water, oftentimes many miles offshore. One example of such a variety of offshore platforms may be found in the Gulf of Mexico off the Southern coast of the United States. It is well known that there has been a continuing trend to locate offshore production platforms farther and farther out into the Gulf of Mexico in deeper and deeper water to produce stabilized crude oil from subsea reservoirs.

In the preferred embodiment of the invention, placed in proximity to one or more offshore production platforms is an unmoored, dynamically positionable FSO 10. As previously indicated, such unmoored, dynamically positionable FSO's 10 include special thruster and propulsion systems 20 to maintain their distance in the water relative to the offshore platforms 100, 200, and 300 or their position with respect to a predetermined point on the earth's surface.

The FSO 10 is connected by one or more flexible hoses to the offshore platforms 100, 200 and 300. Stabilized crude oil produced from one or more of the production platforms continuously flows into an upstream end 32 of the flexible hose 30 and exits at a downstream end 34 of the flexible hose into the unmoored, dynamically positionable FSO 10.

The unmoored, dynamically positionable FSO 10 may be positioned in the water by a signal 40 emitted by a platform to maintain a constant separation distance, to maintain a movement pattern with respect to the motion of an offshore platform (e.g., a floating platform, a platform having an articulated connection to the sea floor, or a platform located on top of a compliant support), or by positioning signals 50 from one or more satellites S identifying a point on the earth's surface, such as the signals used by the well known GPS system. Commonly, multiple such positioning systems are used.

Shuttle tankers 60 offload stabilized crude oil from the unmoored, dynamically positionable FSO 10 and travel to one or more predetermined onshore refineries 400, 500, 600 or storage facilities with their load of crude oil. Either before departure from the FSO 10 or while en route, the shuttle tanker 60 can be properly directed to the onshore refinery or storage facility which either bids the highest price for the load of stabilized crude oil or has the most suitable processing equipment for the stabilized crude oil on board the shuttle tanker, or both. Because of the multiple tanks or compartments 62 on the shuttle tankers 60 and on the dynamically positionable large offshore tanker 10, it is possible for the shuttle tankers 60 to transport different types of stabilized crude oil in separate on-board compartments to multiple onshore refineries or storage facilities.

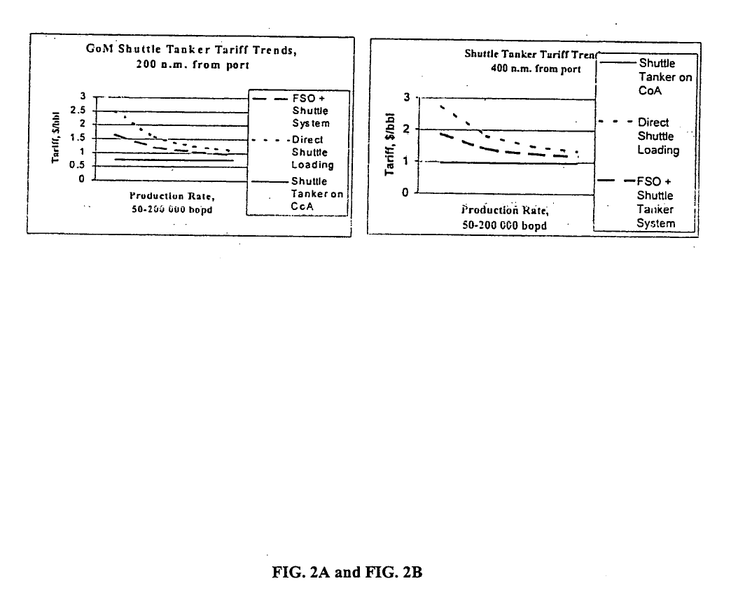

A still better understanding of the benefits provided by the present invention may be had by reference to the two graphs which appear in FIGS. 2A and 2B.

FIG. 2A describes the situation where stabilized crude oil located 200 nautical miles offshore is transported to an onshore location. The y-axis shows the tariff or the cost per barrel of transporting the stabilized crude oil from an offshore well to an onshore refinery or storage facility. The x-axis shows the production rate at the offshore platform in barrels of oil per day. Because the price of previously discussed Contract of Affreightment for transportation from platforms with storage capabilities is a flat fee which is independent of production rate, a horizontal solid line is shown. The dotted line curve on the top reflects when multiple shuttle tankers are used to transport the stabilized crude oil in a Direct Shuttle Loading (DSL) mode where the stabilized crude oil passes directly from an offshore platform without storage capabilities to the shuttle tanker. The dashed line curve in the middle indicates the savings that are obtainable from using an unmoored, dynamically positionable FSO between the production platform and the shuttle tankers.

As may be seen in the curve shown in FIG. 2B, where the production location is located 400 nautical miles offshore, the cost saving impact of using an unmoored, dynamically positionable FSO together with a fleet of shuttle tankers moving the stabilized crude oil to an onshore location, the positive economic impact increases over that shown in FIG. 2A.

While the present system and method has been disclosed according to the preferred embodiment of the invention, those of ordinary skill in the art will understand that other embodiments have also been enabled. Such other embodiments shall fall within the scope and meaning of the appended claims.

1. A system for transporting stabilized crude oil from an offshore production location to one or more onshore refineries or storage facilities, said system comprising:
a flexible hose having a first end and a second end, said first end being in fluid connection with the platform from which crude oil is produced;
an unmoored, dynamically positionable FSO constructed and arranged for fluid connection with said second end of said flexible hose;
at least one shuttle tanker constructed and arranged to offload stabilized crude oil from said unmoored, dynamically positionable FSO and transport the crude oil from said unmoored, dynamically positionable FSO to the one or more onshore refineries or storage facilities.

2. The system as defined in claim 1, wherein said unmoored, dynamically positionable FSO is maintained at a predetermined distance from the offshore production location.

3. The system as defined in claim 1, wherein said unmoored, dynamically positionable FSO is caused to maintain a movement pattern with respect to the motion of an offshore platform.

4. The system as defined in claim 1, wherein said unmoored, dynamically positionable FSO is maintained at a predetermined position with respect to a point on the earth's surface.

5. The system as defined in claim 1, wherein said at least one shuttle tanker is able to change destinations while en route from said FSO.

6. The system as defined in claim 1, wherein the destination of said shuttle tanker is selected form a group of factors including the price paid for the crude oil and the chemical signature of the crude oil.

7. The system as defined in claim 1, wherein said at least one shuttle tanker includes a plurality of compartments for segregating stabilized crude oil with different chemical signatures.

8. A system for transporting stabilized crude oil from an offshore production location without storage capabilities to one or more onshore refineries or storage facilities, said system comprising:
a flexible hose having a first end and a second end, said first end being in fluid connection with the platform from which crude oil is produced;
at least one shuttle tanker constructed and arranged to offload crude oil from the offshore production location without storage capabilities and transport the crude oil to the one or more onshore refineries or storage facilities.

9. The system as defined in claim 8, wherein said at least one shuttle tanker is maintained at a predetermined distance from the offshore production location while the crude oil is being transferred from the offshore production location.

10. The system as defined in claim 8, wherein said at least one shuttle tanker is caused to maintain a movement pattern with respect to the motion of an offshore platform.

11. The system as defined in claim 8, wherein said at least one shuttle tanker is maintained at a predetermined position with respect to a point on the earth's surface.

12. The system as defined in claim 8, wherein said at least one shuttle tanker includes a plurality of compartments for segregating stabilized crude oil with different chemical signatures.

13. A method for transporting stabilized crude oil from an offshore production location to one or more onshore refineries or storage facilities, said method comprising the steps of:
moving the stabilized crude oil from the offshore production location to an unmoored, dynamically positionable FSO;
moving the crude oil from said urnmoored, dynamically positionable FSO to one or more shuttle tankers;
moving the tankers from said unmoored, dynamically positionable FSO to one or more onshore refineries or storage facilities.

14. The method as defined in claim 13, wherein said unmoored, dynamically positionable FSO is maintained at a predetermined position from the offshore production location.

15. The method as defined in claim 13 wherein said unmoored, dynamically positionable FSO is caused to maintain a movement pattern with respect to the motion of an offshore platform.

16. The method as defined in claim 13, wherein said unmoored, dynamically positionable FSO is maintained at a predetermined position with respect to a point on the earth's surface.

17. The method as defined in claim 13, wherein said at least one shuttle tanker is able to change destinations while en route from said FSO.

18. The method as defined in claim 13, wherein the destination of said shuttle tanker is selected from a group of factors including the price paid for the stabilized crude oil and the chemical signature of the stabilized crude oil.

19. A method for transporting stabilized crude oil from an offshore production location without storage capabilities to one or more onshore refineries or storage facilities, said method comprising the steps of:
connecting the first end of a flexible hose to the, offshore production location without storage capabilities;
connecting the second end of said flexible hose to a shuttle tanker;
moving the shuttle tanker to the one or more onshore refineries or storage facilities.

20. The method as defined in claim 19, wherein said shuttle tanker includes a plurality of compartments for segregating stabilized crude oil with different chemical signatures.

21. A method for transporting crude oil from a platform located in deep water to one or more onshore refineries or storage facilities, said method comprising the steps of:
connecting the first end of a flexible hose having a first end and a second end to the platform from which crude oil is produced;
locating an unmoored, dynamically positionable FSO in a position where it may be connected to said second end of said flexible hose;
loading said unmoored, dynamically positionable FSO with crude oil through said flexible hose;
off-loading the crude oil from said unmoored, dynamically positionable FSO to one or more shuttle tankers;
transporting the crude oil to one or more of a plurality of offshore refineries or storage facilities.
